(19) United States
(12) Patent Application Publication
(10) Pub. No.: US 2015/0117558 A1
(43) Pub. Date: Apr. 30, 2015

(54) ORTHOGONAL FREQUENCY-DIVISION MULTIPLEXING (OFDM) PEAK TO AVERAGE POWER RATIO (PAPR) REDUCTION USING LOW COMPLEXITY TRANSFORMATIONS

(71) Applicant: SAMSUNG ELECTRONICS CO., LTD., GYEONGGI-DO (KR)

(72) Inventor: Kieran PHILLIPS, Cambridge (GB)

(73) Assignee: SAMSUNG ELECTRONICS CO., LTD., GYEONGGI-DO (KR)

(21) Appl. No.: 14/243,201

(22) Filed: Apr. 2, 2014

Related U.S. Application Data
(60) Provisional application No. 61/895,688, filed on Oct. 25, 2013.

(51) Int. Cl. H04L 27/26

(52) U.S. Cl. CPC H04L 27/2614
USPC 375/261

(57) ABSTRACT

Methods and apparatus are provided for reducing Peak to Average Power Ratio (PAPR) in Orthogonal Frequency-Division Multiplexing (OFDM) modulation. A set of low complexity transformations is applied to an OFDM signal to generate a plurality of differently transformed OFDM signals. One of the plurality of differently transformed OFDM signals having a lowest PAPR is selected. The selected one of the plurality of differently transformed OFDM signals is transmitted.

### PRIORITY

This application claims priority under 35 U.S.C. §119(e) to a provisional application filed in the United States Patent & Trademark Office (USPTO) on Oct. 25, 2013, and assigned Ser. No. 61/895,688, the contents of which are incorporated herein by reference.

### BACKGROUND OF THE INVENTION

1. Field of the Invention

The present invention relates generally to Orthogonal Frequency-Division Multiplexing (OFDM) Peak to Average Power Ratio (PAPR) reduction, and more particularly, to OFDM PAPR reduction using low complexity time domain transformations.

2. Description of the Related Art

Modern digital communication standards, such as, for example Institute of Electrical and Electronics Engineers (IEEE) 802.11 g/n/ac, use OFDM modulation instead of single carrier type modulation, since OFDM modulation can achieve higher spectrum efficiency with reasonable receiver complexity. While the single carrier type modulation requires a highly linear Power Amplifier (PA) and results in lower power efficiency than OFDM modulation, an OFDM modulated signal has a higher PAPR than a signal resulting from single carrier type modulation.

A number of techniques have been proposed to reduce the PAPR of OFDM modulation. One type of non-distorted PAPR reduction technique performs scrambling on the Quadrature Amplitude Modulation (QAM) symbols. Specifically, this type of technique applies multiple scrambling patterns before performing an Inverse Fast Fourier Transform (IFFT), and selects a resulting OFDM signal having a lowest PAPR.

FIG. 1 is a flow diagram illustrating a method for reducing the PAPR of OFDM modulation. QAM mapping is performed in block 102. Different scrambling patterns are applied in each of blocks 104-1, 104-2, . . . 104-M. IFFT is performed on the differently scrambled QAM symbols in blocks 106-1, 106-2, . . . 106-M. In block 108, a resulting OFDM signal with a lowest PAPR is selected from the signals generated from IFFT blocks 106-1, 106-2, . . . 106-M.

If the cost of scrambling for this type of technique is O(N), there is a requirement of high complexity, i.e., O(M(N+N log₂ N), where M is the size of the pattern set and N is the size of the IFFT.

### SUMMARY OF THE INVENTION

The present invention has been made to address at least the above problems and/or disadvantages and to provide at least the advantages described below. Accordingly, an aspect of the present invention is to use a set of low complexity transformations on an OFDM signal to select a transformed OFDM signal having a lowest PAPR.

According to an aspect of the present invention, a method is provided for reducing PAPR in OFDM modulation. A set of low complexity transformations is applied to an OFDM signal to generate a plurality of differently transformed OFDM signals. One of the plurality of differently transformed OFDM signals having a lowest PAPR is selected. The selected one of the plurality of differently transformed OFDM signals is transmitted.

According to another aspect of the present invention, an apparatus is provided for reducing PAPR in OFDM modulation. The apparatus includes a memory and at least one processor coupled to the memory. The at least one processor is operative to apply a set of low complexity transformations to an OFDM signal to generate a plurality of differently transformed OFDM signals, and select one of the plurality of differently transformed OFDM signals having a lowest PAPR. The apparatus further includes a transmitter coupled to the at least one processor and operative to transmit the selected one of the plurality of differently transformed OFDM signals.

According to another aspect of the present invention, an article of manufacture is provided for reducing PAPR in OFDM modulation. The article of manufacture includes a machine readable medium containing one or more programs, which when executed implement the steps of: applying a set of low complexity transformations to an OFDM signal to generate a plurality of differently transformed OFDM signals; selecting one of the plurality of differently transformed OFDM signals having a lowest PAPR; and transmitting the selected one of the plurality of differently transformed OFDM signals.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other aspects, features, and advantages of the present invention will be more apparent from the following detailed description when taken in conjunction with the accompanying drawings, in which:

FIG. 1 is a flow diagram illustrating a method for reducing the PAPR of OFDM modulation;

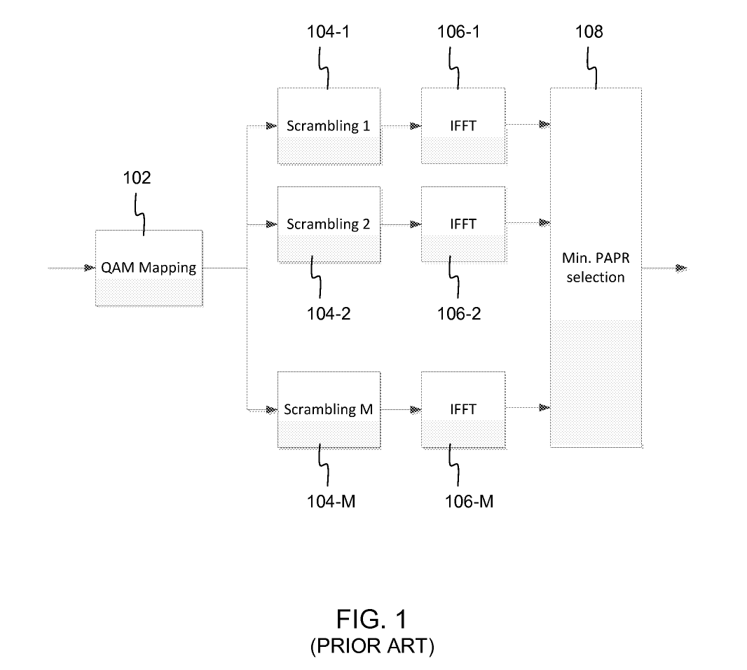

FIG. 2 is a flow diagram illustrating a method for reducing the PAPR of OFDM modulation, in accordance with an embodiment of the present invention;

FIG. 3 is a graph illustrating a comparison of PAPR Complementary Cumulative Distribution Function (CCDF) performance of three PAPR reduction techniques and OFDM modulation without PAPR reduction, in accordance with an embodiment of the present invention; and

FIG. 4 is a block diagram illustrating an example of hardware implementation of a computing system in accordance with which one or more methodologies of the present invention may be implemented.

### DETAILED DESCRIPTION OF EMBODIMENTS OF THE PRESENT INVENTION

Embodiments of the present invention are described in detail with reference to the accompany drawings. The same or similar components may be designated by the same or similar reference numerals although they are illustrated in different drawings. Detailed descriptions of constructions or processes known in the art may be omitted to avoid obscuring the subject matter of the present invention.

In accordance with an embodiment of the present invention, selective mapping PAPR reduction can be expressed as shown in Equation (1).

$$Q ( \vec{x} ) = arg {min}_{{Q}_{k} ∈ Ω} ( max \vert ℱ \cdot {Q}_{k} \cdot \vec{x} \vert ) \qquad ( 1 )$$

In Equation (1), [symbol] is Inverse Discrete Fourier transform defined as shown in

$$\begin{matrix}Equation ( 2 ) & \\ F \cdot \vec{x} = \frac{1}{\sqrt{N}} {\sum }_{n = 0}^{N - 1} x ( n ) \cdot {e}^{i 2 π kn / N} . & ( 2 )\end{matrix}$$

In Equation (1), Ω is a set of pre-selected linear transformations, the set cardinality being M. Ω may be, e.g., a set of block diagonal matrices (a phase scrambler and is called block rotation).

The transformation is reversible so that the receiver side can recover the transmitted signal \vec{x}. To allow a receiver to perform the inverse transformation, the information of the selected transformation should be conveyed or known by the receiver.

In general, the complexity of selecting the transformation with the lowest PAPR is high. However, if the transformation set Ω has a certain structure, the complexity can be reduced.

According to an embodiment of the present invention, a set of low complexity transformations is performed on an OFDM signal. The set of low complexity transformations may include, for example, rotations about a set of pre-defined axes, embedded 2-dimensional rotations, embedded low-dimension unitary transformations, etc.

This structured transformation of the OFDM signal is advantageous in that it has an efficient implementation using linear (low) complexity transformations, it has an equivalent transformation after commuting with Fast Fourier Transform (FFT) (or IFFT), and it is amenable to time domain analysis/heuristics, which can reduce the search space. For example, the transformation can be equivalently performed in the time domain and can target specific features in the time domain.

With these advantages, the complexity of selecting a scrambling pattern with a minimum PAPR is reduced from O(M(N log₂ N+N)), as described above, to O(N log₂ N+NM), for instance N=64×2^{a}, a=0, 1, 2 . . . and M=4×2^{a}. In another embodiment of the present invention, M and N may not follow the relationship shown in the example. The definitions of M and N are provided above.

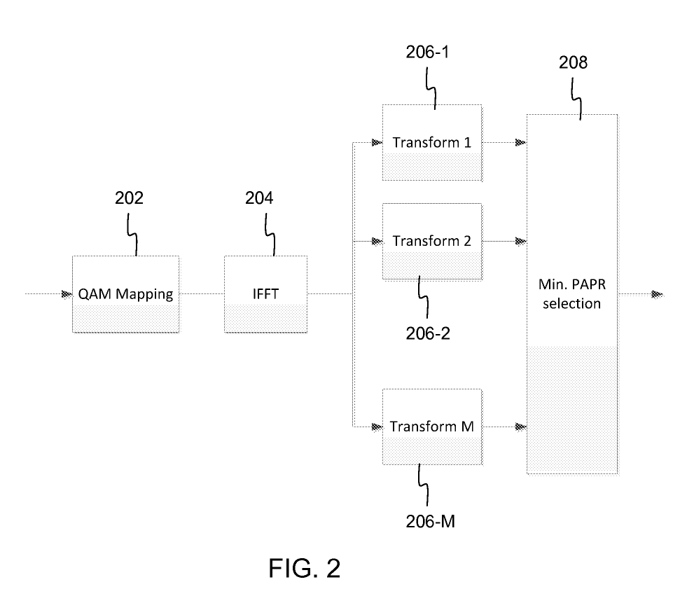

FIG. 2 is a flow diagram illustrating a method for PAPR reduction in OFDM modulation, in accordance with an embodiment of the present invention. Specifically, the methodology of FIG. 2 is performed in an OFDM transmitting apparatus. QAM mapping is performed on received data, in block 202. In block 204, IFFT is performed on the QAM mapped data to generate an OFDM signal. Different low complexity transformations are performed on the OFDM signal in each of blocks 206-1, 206-2, . . . 206-M. In block 208, a resulting transformed OFDM signal having a lowest PAPR is selected. The resulting transformed OFDM signal is then transmitted from the OFDM transmitting apparatus to an OFDM receiving apparatus.

Two schemes are set forth below that achieve low complexity transformation as well as acceptable PAPR reduction.

One manner in which the transform is selected is by using a Fourier conjugate method, which uses rotation transformation with respect to a set of axes \vec{ξ}εC^{N}, as defined below in Equation (3).

Q_{ξ}(\vec{x})=R_{ξ} (3)

In Equation (3), R=[Rᵢⱼ], Rᵢⱼ=δᵢⱼ−2\vec{ξ}ᵢ \vec{ξ}ⱼ

The transformation can be calculated efficiently, i.e., R_{ξ}·\vec{x}=\vec{x}−2(\vec{x}⁺·\vec{ξ})\vec{ξ}.

Moreover, the transformation can be equivalently performed after Fourier transformation, i.e., [symbol] ·Qₖ·\vec{x}= [symbol] ·R_{ξ}·\vec{x} can be calculated as − [symbol] ·\vec{x}+2( [symbol] ·\vec{x})·( [symbol] ·\vec{ξ})· [symbol] ·\vec{ξ}. For the pre-selected set of its equivalent set can be pre-computed as {F·\vec{ξ}}.

The set of transformations is determined by the axis of the rotation. The following set of axes is chosen by setting a sub-block of an element in the vector as one, as shown below in Equation (4).

$${\vec{ξ}}_{k} = \frac{1}{Const} ( \begin{matrix}0 , 0 , 0 , & … & 1 , 1 , … 1 , 1 , & … & 0 , 0 , 0\end{matrix} ) \qquad ( 4 )$$

In Equation (4), Const is set to normalize the vector so that its norm is one.

Another way of selecting the transform is by using a Codim conjugate method, which sequentially rotates by a certain angle in an embedded two-dimension plane spanned by orthonormal basis (\vec{μ},\vec{v}). The rotation is defined below in Equation (5).

R(\vec{μ},\vec{v},\vec{θ})·\vec{x}=\vec{x}−((\vec{μ}⁺·\vec{x})(1−cos θ)+(\vec{v}⁺·\vec{x})sin θ)·\vec{μ}−((\vec{v}⁺·\vec{x})(1−cos θ)−(\vec{μ}⁺·\vec{x})sin θ)·\vec{v} (5)

As shown in Equation (5), the rotation is a lower rank matrix and can be implemented efficiently, i.e., only two dot products and vector additions are used.

This transformation can be equivalently performed after Fourier transformation, i.e., [symbol] ·\vec{x}=\vec{x}_{f}, [symbol] ·\vec{μ}=\vec{μ}_{f}, [symbol] ·\vec{v}=\vec{v}_{f}

[symbol]

·R(\vec{μ},\vec{v},θ)·\vec{x}=R(\vec{μ}_{f},\vec{v}_{f},θ)· [symbol] ·\vec{x}=\vec{x}_{f}−((\vec{μ}_{f}·\vec{x}_{f})(1−cos θ)+(\vec{v}_{f}·\vec{x}_{f})sin θ)·\vec{μ}_{f}−((\vec{v}_{f}·\vec{x}_{f})(1−cos θ)−(\vec{μ}_{f}+·\vec{x}_{f})sin θ)·\vec{v}_{f}

The set of transformations is defined as (P₁), and a vector is defined as \vec{e}ₖ=[0, . . . , 0, 1, 0 . . . , 0], where only a kth element is 1 and all the other elements are 0. Accordingly, the concatenated rotations can be expressed as shown in Equation (6) below.

$${P}_{i} = \text{?} R ( {\vec{e}}_{\frac{iN}{4} + 2 k} , {\vec{e}}_{\frac{iN}{4} + 2 k + 1} , \frac{π}{2} ) \\ \text{?} \text{indicates text missing or illegible when filed} \qquad ( 6 )$$

For both of the above-described methods, the selection of the rotation axes can be modified to preserve the pilot and Direct Current (DC) subcarriers.

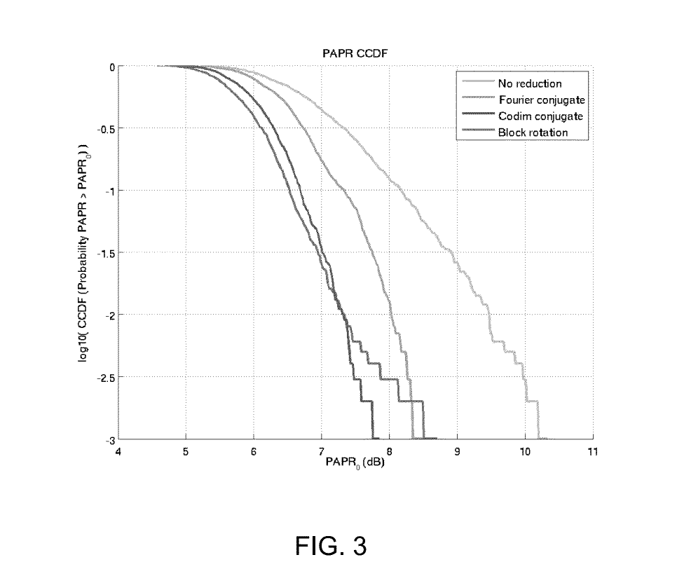

FIG. 3 is a graph illustrating a comparison of PAPR Complementary Cumulative Distribution Function (CCDF) performance of PAPR reduction techniques, in accordance with an embodiment of the present invention. Specifically, FIG. 3 shows PAPR CCDF for OFDM with no reduction, for OFDM with PAPR reduction using the Fourier conjugate, for OFDM with PAPR reduction using the Codim conjugate, and for OFDM with PAPR reduction with scrambling before IFFT using block rotation. All three PAPR reduction techniques assume a set size of four.

As shown in the graph of FIG. 3, the above-described methods using Fourier conjugate and Codim conjugate show a reduced PAPR from OFDM modulation without a PAPR reduction method. Additionally, as shown in FIG. 3, while the block rotation method is shown to have a slightly increased PAPR reduction over Fourier conjugate and Codim conjugate methods for higher CCDF values, the PAPR reduction using the block rotation method becomes less effective than the Fourier conjugate method and the Codim conjugate method at lower CCDF values.

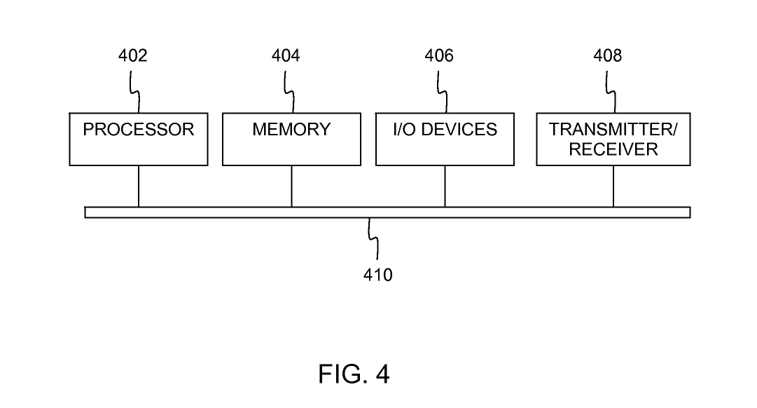

Referring now to FIG. 4, a block diagram illustrates an example of a hardware implementation of a computing system in accordance with which one or more methodologies of the present invention (e.g., the methodology described in the context of FIG. 2) may be implemented. Specifically, according to an embodiment of the present invention, the block diagram of FIG. 4 may relate to an OFDM transmitting apparatus in an OFDM system. As shown, the computing system may be implemented in accordance with a processor 402, a memory 404, I/O devices 406, and a transmitter/receiver 408, coupled via a computer bus 410 or alternate connection arrangement.

It is to be appreciated that the term “processor” as used herein is intended to include any processing device, such as, for example, one that includes a Central Processing Unit (CPU) and/or other processing circuitry. It is also to be understood that the term “processor” may refer to more than one processing device and that various elements associated with a processing device may be shared by other processing devices. The term “memory” as used herein is intended to include a memory associated with a processor or CPU, such as, for example, Random Access Memory (RAM), Read Only Memory (ROM), a fixed memory device (e.g., hard drive), a removable memory device, flash memory, etc.

In addition, the phrase “I/O devices” as used herein is intended to include, for example, one or more input or output devices. Still further, the phrase “transmitter/receiver” as used herein is intended to include, for example, one or more transmitters and receivers to permit the computer system to communicate with another computer system or apparatus via an appropriate communications protocol. Accordingly, in an embodiment of the present invention, the OFDM transmitting apparatus is provided access to an OFDM system, and is able to transmit an OFDM signal over one or more channels.

Software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

While the present invention has been shown and described with reference to certain embodiments thereof, it will be understood by those of ordinary skill in the art that various changes in form and detail may be made therein without departing from the spirit and scope of the invention as defined by the appended claims.

What is claimed is:

1. A method for reducing Peak to Average Power Ratio (PAPR) in Orthogonal Frequency-Division Multiplexing (OFDM) modulation, the method comprising the steps of:
applying a set of low complexity transformations to an OFDM signal to generate a plurality of differently transformed OFDM signals;
selecting one of the plurality of differently transformed OFDM signals having a lowest PAPR; and
transmitting the selected one of the plurality of differently transformed OFDM signals.

2. The method of claim 1, further comprising:
performing Quadrature Amplitude Modulation (QAM) mapping on data to generate QAM mapped data; and
performing Inverse Fast Fourier Transform (IFFT) on the QAM mapped data to generate the OFDM signal.

3. The method of claim 1, wherein a complexity of the low complexity transformations is defined as O(N log₂ N+NM), where M is a size of a pattern set, and N is a size of the IFFT.

4. The method of claim 1, further comprising transmitting information related to a transformation of the selected one of the plurality of differently transformed OFDM signals, wherein the transformation is reversible based on the information.

5. The method of claim 1, wherein applying the set of low complexity transformations comprises performing rotation transformations on the OFDM signal with respect to a set of axes, each axis of rotation of the set of axes corresponding to a different low complexity transformation of the OFDM signal.

6. The method of claim 5, wherein selection of the axes preserves a pilot and one or more Direct Current (DC) subcarriers of the OFDM signal.

7. The method of claim 1, wherein applying the set of low complexity transformations comprises sequentially rotating the OFDM signal by a specified angle in an embedded two-dimensional plane.

8. The method of claim 7, wherein sequential rotation is a lower rank matrix.

9. The method of claim 7, wherein selection of rotation axes preserves a pilot and one or more Direct Current (DC) subcarriers of the OFDM signal.

10. An apparatus for reducing Peak to Average Power Ratio (PAPR) in Orthogonal Frequency-Division Multiplexing (OFDM) modulation, comprising:
a memory;
at least one processor coupled to the memory and operative to: apply a set of low complexity transformations to an OFDM signal to generate a plurality of differently transformed OFDM signals; and select one of the plurality of differently transformed OFDM signals having a lowest PAPR; and
a transmitter coupled to the at least one processor and operative to transmit the selected one of the plurality of differently transformed OFDM signals.

11. The apparatus of claim 10, wherein the at least one processor is further operative to:
perform Quadrature Amplitude Modulation (QAM) mapping on data to generate QAM mapped data; and
perform Inverse Fast Fourier Transform (IFFT) on the QAM mapped data to generate the OFDM signal.

12. The apparatus of claim 10, wherein a complexity of the low complexity transformations is defined as O(N log₂ N+NM), where M is a size of a pattern set, and N is a size of the IFFT.

13. The apparatus of claim 10, wherein the transmitter is further operative to transmit information related to a transformation of the selected one of the plurality of differently transformed OFDM signals, wherein the transformation is reversible based on the information.

14. The apparatus of claim 10, wherein the processor is operative to apply the set of low complexity transformations by performing rotation transformations on the OFDM signal with respect to a set of axes, each axis of rotation of the set of axes corresponding to a different low complexity transformation of the OFDM signal.

15. The apparatus of claim 14, wherein selection of the axes preserves a pilot and one or more Direct Current (DC) subcarriers of the OFDM signal.

16. The apparatus of claim 10, wherein the processor is operative to apply the set of low complexity transformations by sequentially rotating the OFDM signal by a specified angle in an embedded two-dimensional plane.

17. The apparatus of claim 16, wherein sequential rotation is a lower rank matrix.

18. The apparatus of claim 16, wherein selection of rotation axes preserves a pilot and one or more Direct Current (DC) subcarriers of the OFDM signal.

19. An article of manufacture for reducing Peak to Average Power Ratio (PAPR) in Orthogonal Frequency-Division Multiplexing (OFDM) modulation, comprising a machine readable medium containing one or more programs, which when executed implement the steps of:
applying a set of low complexity transformations to an OFDM signal to generate a plurality of differently transformed OFDM signals;
selecting one of the plurality of differently transformed OFDM signals having a lowest PAPR; and
transmitting the selected one of the plurality of differently transformed OFDM signals.
